(19) United States
(12) Patent Application Publication
(10) Pub. No.: US 2008/0307943 A1
(43) Pub. Date: Dec. 18, 2008

(54) UNIVERSAL GRAND PIANO PIANO ACTION WITH SIMULTANEOUS HALF STROKE KEYBOARD DESIGN CAPABILITY

(76) Inventors: Bruce E. Clark, Nottingham, NH (US); Kevin Burke, Haverhill, MA (US); Kirk Burgett, Sacramento, CA (US)

Correspondence Address: CRAIG A. SIMMERMON, 251 LYMAN CIR., SACRAMENTO, CA, 95835, US

(21) Appl. No.: 11/970,655

(22) Filed: Jan. 8, 2008

Related U.S. Application Data
(62) Division of application No. 11/762,990, filed on Jun. 14, 2007.

(51) Int. Cl. G10C 3/22

(52) U.S. Cl. 84/239

(57) ABSTRACT

A universal grand piano piano action that has adjustable connections between the repetition base, heel, and rest cushion bracket of the piano action to provide a one-size-fits-all after-market replacement piano action for any grand piano. Other components of the grand piano piano action, such as the jack and flanges, may require specific design and manufacture for each brand of grand piano. This invention is the first piano action to allow for true simultaneous half stroke keyboard design for both the white and sharp keys of a piano and includes the method for installing such.

### CROSS-REFERENCE TO RELATED APPLICATIONS

The instant application is a divisional of U.S. Application No. 11/762,990 entitled “Grand Piano Composite Piano Action” filed on Jun. 14, 2007, which is hereby incorporated by reference herein. Claim 7 of the parent application is the only claim in that application relevant to matter contained in the instant application.

### BACKGROUND OF INVENTION

A grand piano piano action consists of a repetition base, balancier, balancier regulating button, jack, jack regulating button, heel, rest cushion bracket, rest cushion, shank flange, repetition flange, and stop for jack regulating button. In order for an after-market grand piano piano action to properly fit an existing grand piano configuration, the following must occur. 1) The repetition hole-to-hole distances must remain constant between the after-market and existing repetition bases. 2) The after-market action must accommodate the existing capstan contact point of the piano. 3) The shank flange and repetition flange of the after-market action must fit the existing rails on the piano. 4) The after-market jack must have the appropriate shape to function properly with the two regulating buttons of the action. 5) The rest cushion and rest cushion bracket must accommodate the existing hammer of the piano-noting that some grand piano designs require an attached rest cushion to the repetition base while others do not.

We have analyzed these requirements and created a universal piano action that can be installed into most grand pianos with very little inconvenience.

Potential benefits include providing the capability for piano technicians and retail piano outlets to stock just one replacement action, namely the Universal Grand Piano Piano Action, in order to reduce inventory while also having immediate stock on hand to repair or tune any grand piano at ready call. Benefits also include the ability to conveniently install proper simultaneous half stroke keyboard design for both the white and sharp keys into any grand piano.

### OBJECT OF INVENTION

It is the object of this invention to produce a universal grand piano piano action that can be successfully installed in most grand pianos. This objective is met through the novel design of a repetition base, heel, rest cushion bracket, rest cushion, jack, jack regulating button, balancier, balancier regulating button, shank flange, and repetition flange. The novel design includes various modes of each component.

It is also an object of this invention to provide the capability to install simultaneous half stroke design for both the white and sharp keys into any grand piano. As noted in the parent application, half stroke design is useful because it is the optimum keyboard design that minimizes friction losses in the piano action and thereby results in a piano action with reduced touch weight, further resulting in a lighter, faster, and more responsive piano action.

### BRIEF DESCRIPTION OF THE DRAWINGS

FIG. 1 is a front view of the best mode of a universal piano action.

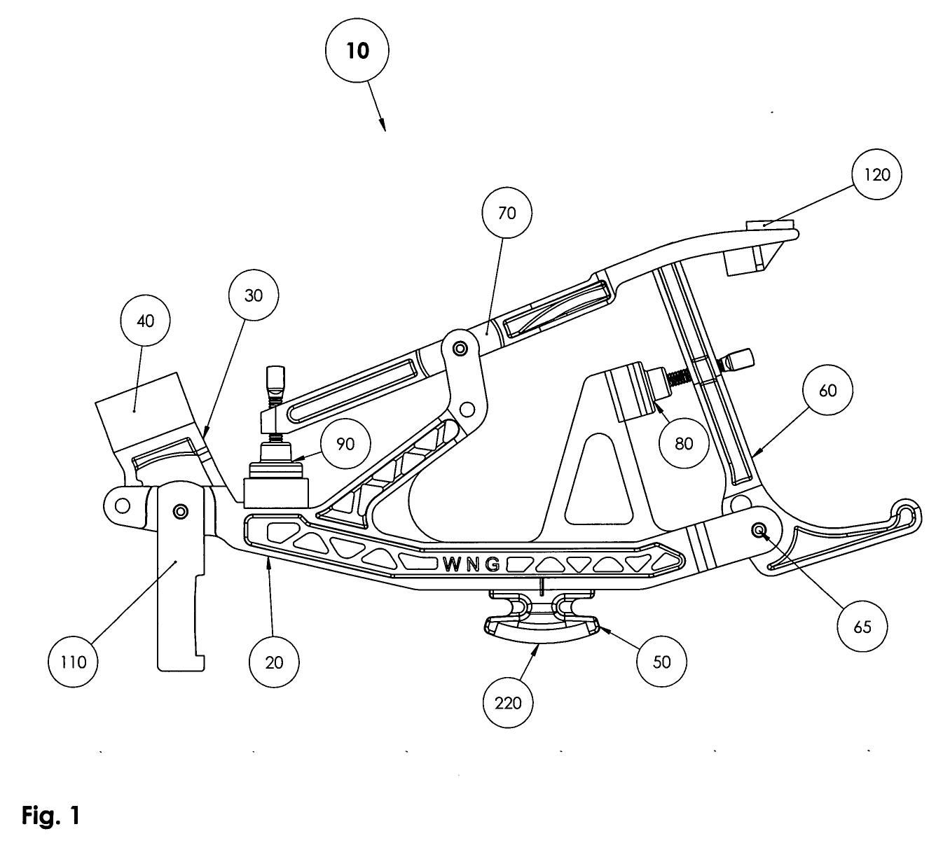

FIG. 2 is a front view of the best mode of a repetition base.

FIG. 3 is a bottom view of the best mode of a repetition base.

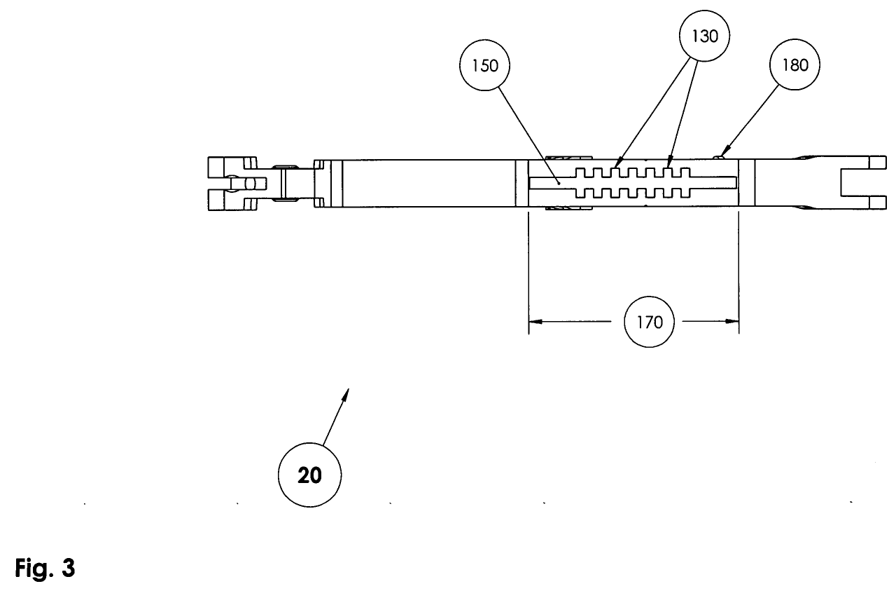

FIG. 4 is a top view of the best mode of a repetition base.

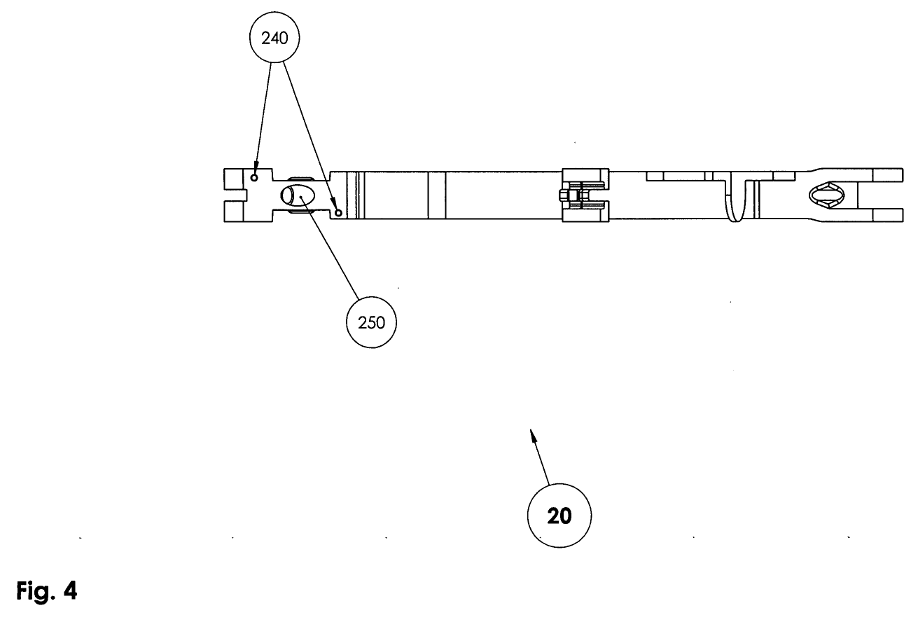

FIG. 5 is a side view, end view, and top view of a mode of a heel.

FIG. 6 is a side view of two heels with different heights.

FIG. 7 is a side and prospective view of the best mode of a rest cushion bracket.

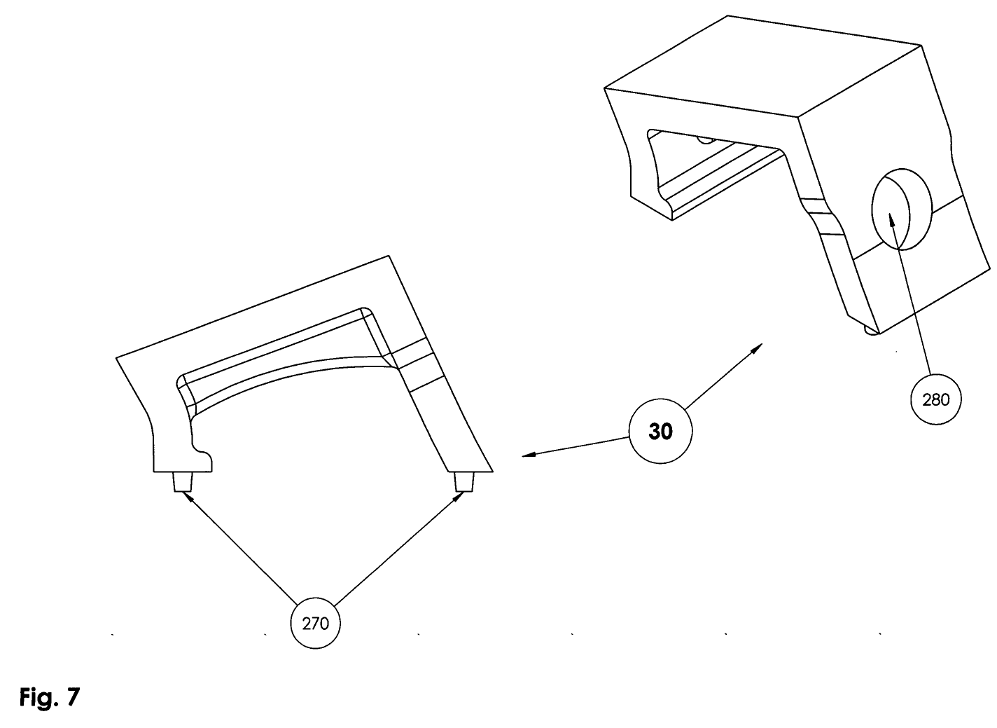

FIG. 8 is a graphic depiction of the best mode of a universal piano action, with attention drawn to half stroke design criteria.

DEFINITION LIST

| Term | Definition |
|---|---|
| 10 | Piano Action |
| 20 | Repetition Base |
| 25 | Repetition Base Main Beam |
| 28 | Repetition Base Center of Rotation |
| 30 | Rest Cushion Bracket |
| 40 | Rest Cushion |
| 50 | Heel |
| 60 | Jack |
| 65 | Jack Center of Rotation |
| 70 | Balancier |
| 80 | Jack Regulating Button |
| 90 | Balancier Regulating Button |
| 100 | Stop for Jack Regulating Button |
| 110 | Repetition Flange |
| 120 | Shank End of Balancier |
| 130 | Repetition Notches to Accept Heel Ridges |
| 140 | Heel Ridges |
| 150 | Repetition Main Channel to Accept Heel Main Rib |
| 160 | Heel Main Rib |
| 170 | Heel Attachment Range |
| 180 | Repetition Location Notch |
| 190 | Heel Location Notch |
| 200 | Heel Orientation Notch |
| 210 | Jack Center Line |
| 220 | Capstan Contact Point |
| 225 | Heel Cushion |
| 230 | Nominal Heel Height |
| 240 | Rest Cushion Bracket Positioning Holes |
| 250 | Helper Spring Adjustment Hole on Repetition Base |
| 260 | Actual Heel Height |
| 270 | Rest Cushion Bracket Locating Pins |
| 280 | Helper Spring Adjustment Hole on Rest Cushion Bracket |
| 290 | Repetition Center Vertical Offset (VO) |
| 300 | Capstan Contact Horizontal Distance (HD) |
| 310 | Repetition Lower Lever Arm (RLLA) |

### DETAILED DESCRIPTION OF EMBODIMENT(S)

The invention includes a universal repetition base 20 and a range of universal heels 50 of varying heights that are capable of being installed into any manufacturer's grand piano. This is accomplished by allowing for the selection of heel 50 with proper height 260 for a specific brand of grand piano and further allowing the proper heel 50 to be attached to a universal repetition base 20 at various locations along the repetition main beam 25 of the repetition base 20.

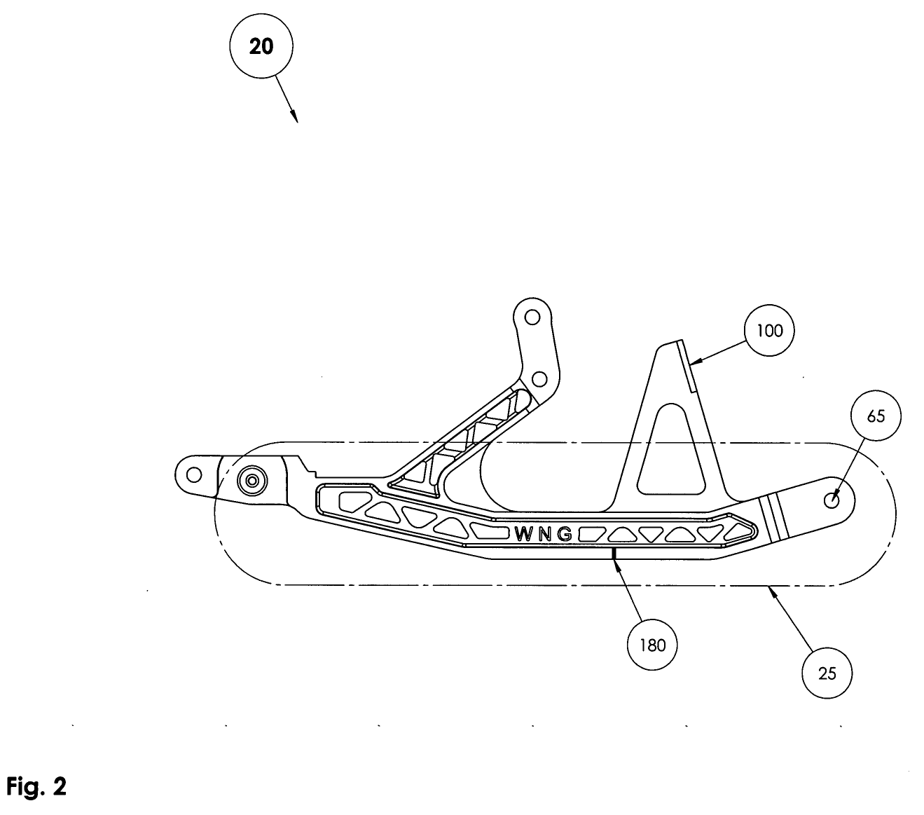

The repetition main beam 25 is defined as the lower beam of the repetition base 20, which supports other structure of the repetition base 20, namely a beam to support the balancier 70 and structure to support the stop for jack regulating button 100. See FIG. 2 for a depiction of the repetition main beam 25. The main beam 25 is the beam that is encircled in FIG. 2. The repetition main beam 25 makes up the majority of the repetition base 20. By varying the connection between these two piano action components, the universal piano action 10 can conform to a specifically required distance between the existing repetition rail (located beneath repetition flange 110) and the existing capstan point 220 of the particular brand of grand piano.

The universal repetition base 20 may be connected to a rest cushion bracket 30 in order to fit those brands of grand piano that require an integral repetition base 20 with rest cushion 40, or the rest cushion bracket 30 may be left off to accommodate those brands that do not require such and integrated action member. If the rest cushion bracket 30 is not attached to the repetition base 20, the rest cushion bracket 30 is simply left in place on the existing piano and is not required for an action assembly 10 replacement. A specific rest cushion 40 is required for each brand of grand piano for which the after-market piano action 10 is to be installed.

A specifically designed jack 60 may be required for each brand of grand piano for which the after-market piano action 10 is to be installed. This is because the jack length and angle of the jack tender must correctly interact with other piano components, primarily the regulating buttons 80 and 90 of the action 10 and the hammers of the piano. A single mode of jack 60, however, may function properly in more than one brand of grand piano. For instance, the invention includes a single design of jack 70 that functions properly in all Steinway grand pianos as well as all Mason & Hamlin grand pianos.

A specific shank flange and repetition flange 110 must be designed for each brand of grand piano for which the after-market piano action 10 is to be installed.

A mode of the repetition base 20 is designed with notches 130 that are used to locate and accept ridges 140 on the heel 50. The repetition base 20 is also designed with a main channel 150 to locate and accept the heel main rib 160. One mode of the invention allows the heel 50 to be located and attached to the repetition base 20 along a 21 mm range at 170. This range is varied in other modes. Typically the heel 20 is attached to the repetition base 20 with glue.

One mode of repetition base 20 has notches 130 separated by 3 mm center-to-center distances. A mode of heel 50 has ridges 140 offset from the center of the heel 50 by 1.5 mm. In this configuration, the heel 50 may be conveniently adjusted along the length of the repetition base 20 in 1.5 mm increments by rotating the heel 50 by 180° in relation to the repetition base 20 for each 1.5 mm increment. Alternately, the heel 50 could be moved by full 3 mm increments without such rotation of heel 50. This design allows for fast and precise location of the heel 50 onto the repetition base 20.

One mode of the repetition base 20 contains a location notch 180. Also, one mode of the heel 50 contains location notches 190, which are located at heel center. These notches provide an initial indication point or orientation point from which to start the location procedure between the two components. Some fine tuning procedures, such as proper simultaneous half stroke design, require exact positioning between the heel 50 and the repetition base 20. In addition, a mode of the heel 50 includes an orientation notch 200. This notch is placed on one end only of the heel 50 to provide additional orientation guidance regarding proper positioning of the heel 50, noting that the orientation notch 200 may yield a 1.5 millimeter difference in location, depending on whether the notch 20 is on one side of the repetition base 20 or the other. These indicator points provide a convenient starting point from which to begin the precise location process in order to achieve certain desired keyboard conditions like true simultaneous half stroke keyboard design in a fast, convenient, and accurate way.

A calculation can be performed to yield instructions to create true simultaneous half stroke keyboard design for both the white and sharp keys of the piano. These instructions can be incorporated into a “half stroke design setup sheet” which is can be used by a piano technician to install simultaneous half stroke keyboard design into a piano. The input data for such a calculation are the design criteria of the specific grand piano, called out below, and the design criteria of the universal piano action 10, also called out below. A half stroke design setup sheet comprises location instructions regarding the relative positioning of notches 180, 190, 200, as well as heel height 260.

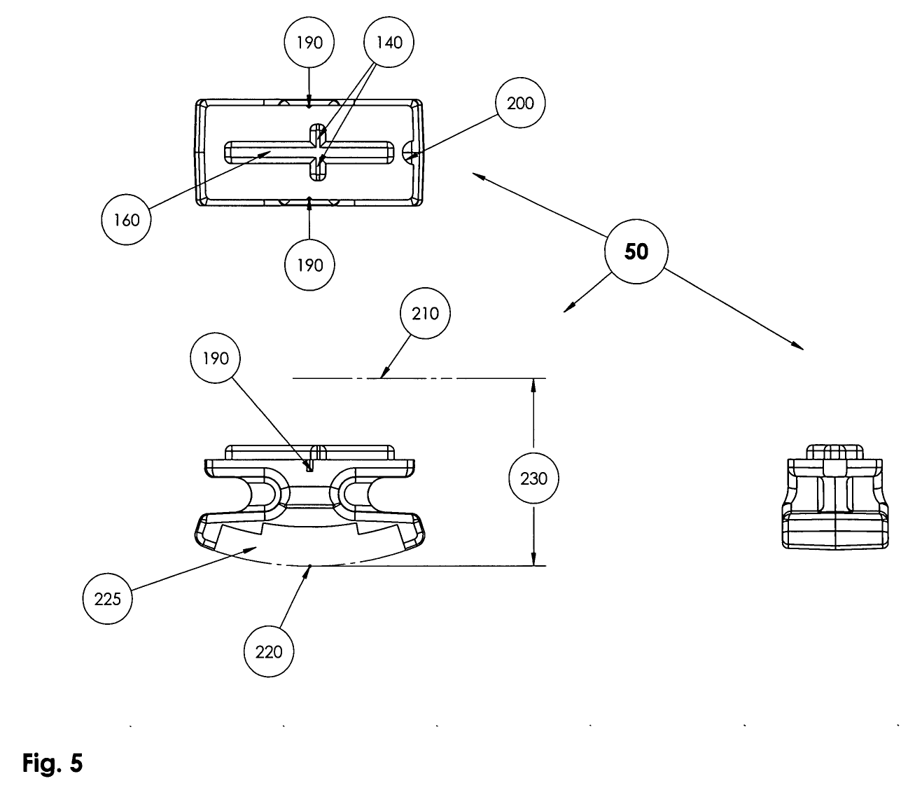

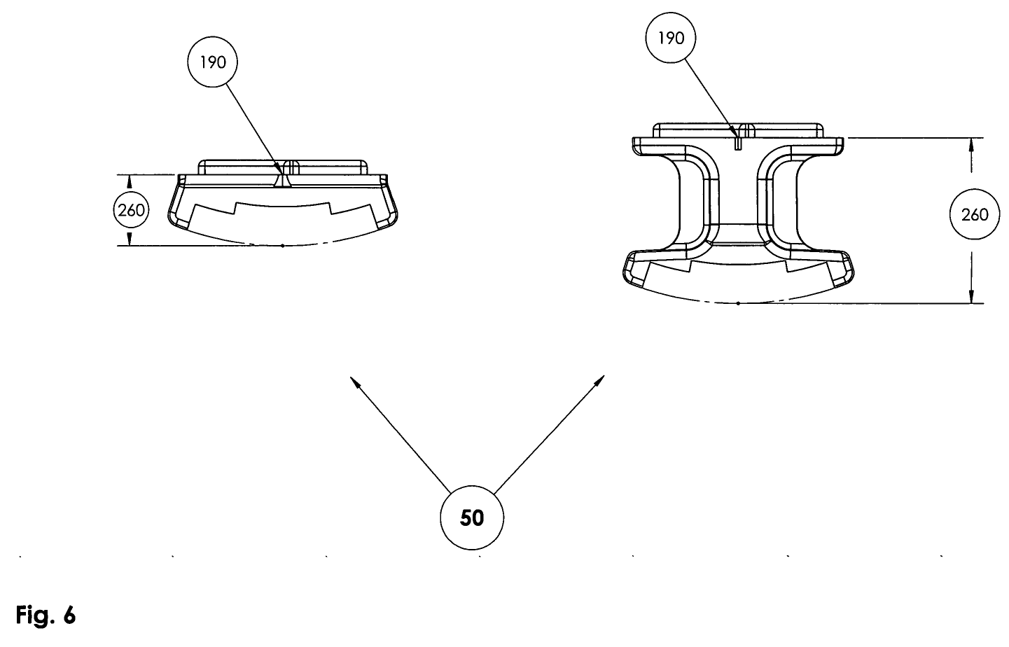

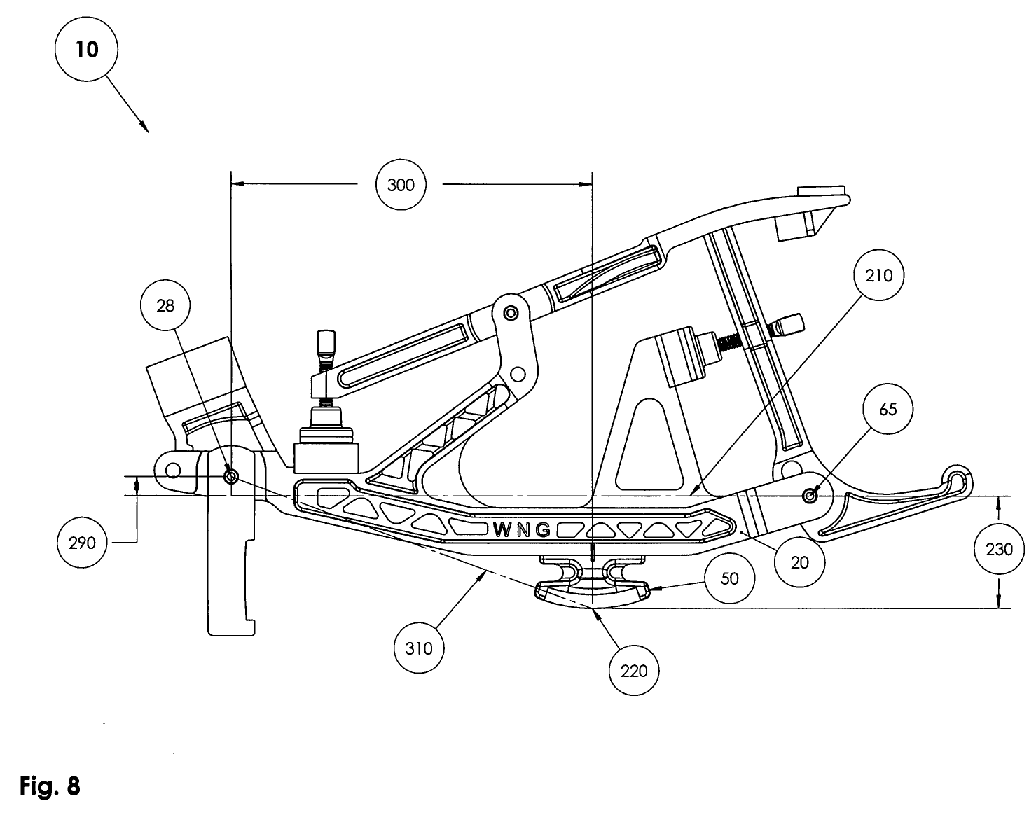

The invention includes heels 50 with multiple heights in order to accommodate different piano designs and to allow for simultaneous half stroke design. In order to label heel height sizes with quantifications that are more conveniently feed into a half stroke design calculation, we have sized heels according to a nominal height 230. Nominal heel height 230 is defined as the perpendicular distance from the jack center line 210 to the capstan contact point 220 of a specific action corresponding to a particular brand of grand piano targeted for after-market replacement. See FIGS. 5 and 8 for a depiction of the nominal heel height 230. The jack center line 210 is defined as a hypothetical line stretching from the jack center of rotation 65 to a perpendicular intersect with the repetition flange 110. See FIG. 8 for a depiction of the jack center line 210. The capstan contact point 220 is the point at which the capstan of the piano should contact the heel cushion 225. One mode of the invention includes 9 nominal heel height sizes, with a nominal heel height 230 ranging from 16-24 mm with 1 mm increments. The actual heel height 260 also may be referenced and is depicted on FIG. 6 for both a relatively short heel 50 and relatively tall heel 50.

In order to install the action components 10 disclosed in this application in a fashion that yields a proper simultaneous half stroke keyboard design, four critical dimensions of the piano action 10 must first be determined. These dimensions are: capstan contact horizontal distance 300 (HD), nominal heel height 230 (HH), repetition vertical offset 290 (VO), and repetition lower lever arm 310 (RLLA). See FIG. 8 for a depiction of these criteria. HD 300 is defined as the horizontal distance between the repetition base center of rotation 28 and capstan contact point 220. VO 290 is defined as the vertical distance between the repetition base center of rotation 28 and the jack center of rotation 65. RLLA 310 is defined as the diagonal distance between the repetition base center of rotation 28 and the capstan contact point 220. These criteria must first be determined in order to attain half stroke design because half stroke design calls for the exact placement of the capstan contact point 220 on the half stroke line. The half stroke line is defined as a theoretical line drawn from the repetition center of rotation 28 through the capstan contact point 220 and extending down to the corresponding key balance point, at a point in time when the repetition 20 is exactly half way through a key-strike cycle, where such cycle starts with the repetition at rest and ends with the striking of the corresponding piano string. The half stroke line is also defined in the parent application and is depicted in a figure in that application.

Note the above criteria may still be adjusted to achieve half stroke design notwithstanding the fact that the capstan is necessarily fixed in location because it is located on the preexisting grand piano. This is because the capstan contact point location 220 may still be adjusted slightly relative to the repetition base 20. The capstan contact point may be located at any point on the heel cushion 225, which is wide relative to the capstan and has a curved surface. This provides the capability to adjust the capstan contact point 220 slightly relative to the repetition base 20. Slight adjustment is all that is required to achieve simultaneous half stroke design. Pianos are designed for white key half stroke design only; this invention provides the slight adjust required to achieve white and sharp key half stroke design.

Any change in one of the criteria 300, 230, 290, or 310 necessarily changes the others, and therefore changes the capstan contact point 220 location. This is so because these distances make a right triangle with sides calculable by the Pythagorean Theorem. I.e., RLLA²=HD²+(HH+VO)²; or, 310²=300²+(230+290)². Any change in one side of the right triangle necessarily changes the other sides of the right triangle. Also note that heels 50 of this invention are made according to a limited number of distinct heights 260; thus, criterion 230 is limited to a select number of distinct lengths as well. Also note that, with the best mode of this invention, heels 50 can only be attached to the repetition base 20 at certain distinct locations; thus, the capstan contact horizontal distance 300 is also limited to a certain number of distinct lengths. Hence, there is more than one variable in the geometry at hand, and two of the variables are limited, in the best mode, to certain distinct distances. To complicate matters even more, the Pythagorean Theorem is a non-linear equation. The net result is that half stroke criteria 300, 230, 290, or 310 cannot be calculated with simply one iteration of the calculation. Rather, we must undergo several iterations in order to determine the optimum capstan contact point 220 and its corresponding optimal criteria 300, 290, 230, and 310, in order to create a half stroke design setup sheet specifying the relative positioning of notches 180, 190, 200, as well as the optimal heel height 260 of the universal grand piano piano action 10.

To be optimal, i.e. yield half stroke design, the piano action 10 must yield a capstan contact point 20 location that is as close as possible to the half stroke line, within the limitations of the best mode which includes distinct limitations on distances 230 and 300. In other words, the half stroke design setup sheet should reference the location of point 220 that is as close as possible to the half stroke line using the best nominal heel height 230 and the best heel 50 repetition base 20 connection location.

The start of the calculation might first assume a certain nominal heel height 230, which is basically an initial guess of which heel height 260 will yield half stroke design. The first iteration would then yield a repetition lower lever arm 310 distance which then would be assessed to determine whether it yielded a capstan contact point 220 that lies on the half stroke line. If it doesn't, another heel height 260 is fed into another iteration of the calculation, yielding another repetition lower lever arm 310 distance and capstan contact point 220.

After each iteration described above, another group of iterations must be done to determine the optimum capstan contact horizontal distance 300. Thus, a certain heel location would fed into the calculation to yield a certain criteria 300 of the action 10, which then would be assessed against the previous determination of criteria 310 to determine whether both criteria yield half stroke design. The chances are that it will not, and thus more iterations would need to be conducted until optimal design criteria is determined. Since only one distance may be varied at a time in any one iteration of the calculation, very many iterations are required to hone in on the proper half stroke keyboard setup criteria.

This calculation lends itself to be conducted more efficiently by computer software. The applicants have devised such a computer program and will file for patent protection on this software.

Once the proper half stroke design setup sheet is determined, the piano technician can then assemble the heel 50 with optimal height 260 to the repetition base 20 at the optimal location, which results in a capstan contact point 220 that lies on the half stroke line. Proper simultaneous half stroke design for both the white and sharp keys requires this calculation to be done for each key of the piano. Note that, with the best mode, half stroke design can be succinctly and accurately communicated with simple instructions regarding the relative positioning of notches 180, 190, 200, as well as nominal heel height 230 for each key, both white and sharp, of a certain brand of grand piano. This application claims the method of installing into a grand piano proper simultaneous half stroke keyboard design.

A mode of the repetition base 20 includes rest cushion bracket positioning holes 240. These holes act as universal positioning holes for whatever specific rest cushion bracket 30 that may be required (if any) for a particular brand of grand piano. Pins 270 on the rest cushion bracket 30 mate with the rest cushion bracket positioning holes 240 on the repetition base 20 to provide for a convenient location and attachment means. Attachment is typically done with glue. Note that the pins could just have easily have been located on the repetition base and the holes located on the rest cushion bracket. This invention includes all connection systems to connect various versions of rest cushion brackets 30 to a universal repetition base 20.

What is claimed is:

1. A repetition base for a grand piano piano action comprising:
a means to adjustably connect a heel, and
a main beam,
wherein said means to adjustably connect a heel connects a heel for a grand piano piano action to said repetition base for a grand piano piano action at one of a plurality of designated connection locations along said main beam.

2. A plurality of heels for a grand piano piano action wherein each of said
plurality of heels for a grand piano has:
height of 5-25 millimeters, and
a means to adjustably connect a repetition base,
wherein said means to adjustably connect a repetition base connects a repetition base for a grand piano piano action to one of said plurality of heels for a grand piano at one of a plurality of designated connection locations along the main beam of said repetition base.

3. A grand piano piano action comprising:
a repetition base,
a heel, and
a heel connection system,
wherein said heel can be located and attached to said repetition base at multiple distinct points along the main beam of said repetition base, thereby accomplished by said heel connecting system.

4. A repetition base as in any of the preceding claims, wherein said repetition base further comprises a means to connect a rest cushion bracket for a grand piano piano action.

5. A method to install simultaneous half stroke keyboard design into a grand piano comprising the steps of:
a. calculating capstan contact point horizontal distance (300), nominal heel height (230), repetition vertical offset (290), and repetition lower lever arm (310) of a grand piano piano action that yields a capstan contact point (220) of said grand piano piano action that essentially lies on the half stoke line of said grand piano piano action for each white and sharp key of said grand piano;
b. attaching a heel with said nominal heel height (230) to a repetition base with said repetition vertical offset (290) at a location on said repetition base that yields said capstan contact point horizontal distance (300) and repetition lower lever arm (310); and
c. installing said heel attached to said repetition base with said criteria capstan contact point horizontal distance (300), nominal heel height (230), repetition vertical offset (290), and repetition lower lever arm (310) into said grand piano for each white and sharp key of said grand piano.
